(19) United States
(12) Patent Application Publication
(10) Pub. No.: US 2025/0200534 A1
(43) Pub. Date: Jun. 19, 2025

(54) Systems and Methods to Securely Identify a User

(71) Applicant: Ramsee 1 LLC, New York, NY (US)

(72) Inventors: Alan RECHTSCHAFFEN, New York, NY (US); Miera RECHTSCHAFFEN, New York, NY (US)

(21) Appl. No.: 18/541,393

(22) Filed: Dec. 15, 2023

(51) Int. Cl. G06Q 20/06; G06Q 20/36

(52) U.S. Cl. CPC G06Q 20/065; G06Q 20/3678

(57) ABSTRACT

A system having a memory and a processor communicatively coupled to the memory and configured to generate digital currency units, wherein each of the digital currency units comprises an indication of a benefit associated with the corresponding digital currency unit, create blocks of a distributed ledger, wherein each block corresponds to one of the digital currency units, wherein each block records the indication of the benefit corresponding to one of the digital currency units, communicate each block to a distributed ledger responsive to exchange of the digital currency unit corresponding to each block, register and validate a user and issue a first one of the digital currency units to the user, wherein the issuing the first one of the digital currency units to the user comprises recording information related to the user on a blockchain responsible for the first one of the digital currency units.

### BACKGROUND

Customer loyalty programs are used widely across many different retail environments, e.g., grocery stores, department stores, luxury goods stores, airlines, etc. These customer loyalty programs may allow the retailer (or other entity) to provide benefits to customers such as access to exclusive discounts, exclusive products, etc. to which only members of the customer loyalty program have access.

Customer loyalty programs have an inherent security issue. For example, a customer typically signs up or is invited to sign up for the customer loyalty program through the use of a website or mobile application using credential information such as a user name and password. Those skilled in the art understand that in today's world these types of credential information are vulnerable to identity theft through phishing scams, cyberattacks, etc. Because of the potential identify theft, there is no guarantee that the person accessing the benefits of the customer loyalty program is in fact the person that is deserving of the benefit. Thus, there is a need to solve the security issue related to customer loyalty programs.

### SUMMARY

Some example embodiments are related to a system having a memory and a processor communicatively coupled to the memory. The processor is configured to generate digital currency units, wherein each of the digital currency units comprises an indication of a benefit associated with the corresponding digital currency unit, create blocks of a distributed ledger, wherein each block corresponds to one of the digital currency units, wherein each block records the indication of the benefit corresponding to one of the digital currency units, communicate each block to a distributed ledger responsive to exchange of the digital currency unit corresponding to each block, register and validate a user and issue a first one of the digital currency units to the user, wherein the issuing the first one of the digital currency units to the user comprises recording information related to the user on a blockchain responsible for the first one of the digital currency units.

Other example embodiments are related to a system having a memory and a processor communicatively coupled to the memory. The processor is configured to receive a digital currency unit comprising an indication of a benefit associated with the digital currency unit, wherein the digital currency unit is associated with one or more blocks of a distributed ledger, wherein the one or more blocks record the indication of the benefit corresponding to the digital currency unit, store the digital currency unit in a digital wallet corresponding to a user, send a request comprising linking the digital wallet including the digital currency unit to an entity that issued the digital currency unit and receive a response including the indication of the benefit associated with the digital currency unit.

### BRIEF DESCRIPTION OF THE DRAWINGS

FIG. 1 is a block diagram of an example system 100 according to various example embodiments.

FIG. 2 illustrates the distribution of the cryptocurrency to qualified customers of a customer loyalty program according to various example embodiments.

FIG. 3 illustrates a flow chart for using the cryptocurrency to purchase goods or services from a provider of goods or services according to various example embodiments.

FIG. 4 illustrates a member-to-member cryptocurrency transfer according to various example embodiments.

FIG. 5 illustrates a flow chart for using the cryptocurrency to receive offers from a provider of goods or services in a brick and mortar location of the provider of goods and services according to various example embodiments.

FIG. 6 is a block diagram of a special purpose computer system on which various functions discussed herein may be practiced according to various example embodiments.

### DETAILED DESCRIPTION

The example embodiments may be further understood with reference to the following description and the related appended drawings, wherein like elements are provided with the same reference numerals. The example embodiments relate to using cryptocurrency tokens for security and identity management of a customer in a customer loyalty program.

In addition to the security issues described above with reference to customer loyalty programs, there may also be other technical issues related to the benefits of customer loyalty programs. For example, there are technical issues related to the transferability of such benefits, e.g., are the benefits transferable, are they intended for only an original recipient, do they expire, etc. There is no current solution for these transferability issues because the benefits are tied to a specific user account. Thus, at the user level, there is no manner of transferring these benefits (either in whole or in part) to a different user account. At the retailer level, there is no manner of recording and verifying transfers of benefits.

Cryptocurrency may be a digital asset that operates in the same manner as fiat currency, e.g., cryptocurrency may represent value that may be used to acquire goods and services. The cryptocurrency may be an open ecosystem entity such as bitcoin that may be accepted by multiple entities that sell goods or services. The cryptocurrency may also be a closed ecosystem, e.g., a larger retailer may issue a cryptocurrency that may only be exchanged for goods and services at the retailer. There may also be hybrid cryptocurrencies that are somewhere between a fully open ecosystem and a closed ecosystem.

The example embodiments are described with reference to an example cryptocurrency where record keepers generate hash values when a transaction occurs and if approved a “block” is created to add to a distributed ledger that may be used to validate exchanges and/or other operations. A blockchain is a chain of these entries and is, in essence, the ledger itself. The blockchain is supported across multiple computers (nodes) that are linked in a peer-to-peer network. Blockchain technology is designed to solve the “trust problem.” It creates a verifiable ledger that no one node may compromise. It is transparent, time-stamped and decentralized. The example embodiments make use of the blockchain technology to solve the issues related to security and transferability of benefits for the example cryptocurrency. In the example embodiments, a unit or units of the cryptocurrency may be referred to as “tokens” or “coins.” Thus, throughout this description, the terms cryptocurrency, tokens or coins may be used interchangeably.

The following provides a description of an example cryptocurrency that may be used to implement the example embodiments. However, it should be understood that the example embodiments are not limited to use with the described cryptocurrency, e.g., those skilled in the art will understand how to apply the example embodiments to any cryptocurrency scheme.

Those skilled in the art will understand how various cryptocurrencies use blockchain technology to encrypt the cryptocurrency. For example, in some blockchain technologies, the data associated with a new transaction becomes a new block. This block has a cryptographic hash that includes information that may link the block to the most recent block in the blockchain, a time of the transaction, and a record of transaction information. The blocks of a blockchain may link in chronological order and be recorded in a distributed ledger. Each coin or token of the cryptocurrency may include this blockchain information that uniquely identifies the coin or token. In the example embodiments, the blocks may be extended to include information related to the example customer loyalty program. For example, this information may include an identification of a benefit to which the holder of the coin is entitled. Some examples of the benefits are described in various use cases provided below. This information may also include an identification of whether the benefit expires, whether the benefit is transferable or whether a benefit associated with the token has been redeemed, e.g., the token may still be valid for some transactions but may be expired or invalid for other transactions.

The example embodiments allow the cryptocurrency token to act as a definitive identifier of customer status. This relieves the customer of having to remember/save credential information such as user name and password information and also prevents this type of credential information from being stolen in an identify theft. Rather, the cryptocurrency token that is in the customer's electronic wallet acts as the identifier of the customer and the benefits to which the customer is entitled. This solves the security and identity management issue for both the customer and the retailer and holds potential for diverse application across multiple industries, including airlines, hotels, retailers, and restaurants. Some example use cases of the example embodiments are described in further detail below.

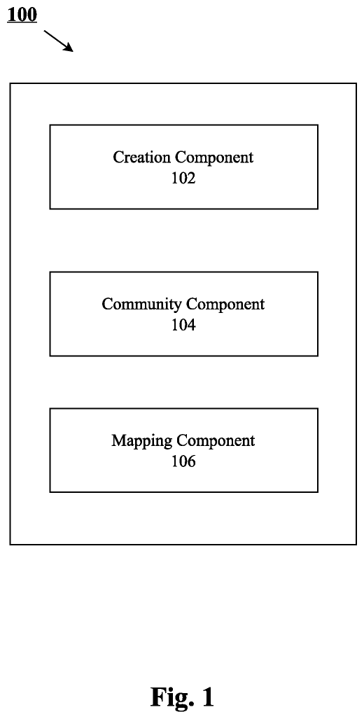

FIG. 1 is a block diagram of an example system 100 according to various example embodiments. According to various example embodiments, the system 100 may be configured to execute any of the described functions herein to instantiate specific system components tailored to execute specific functions. The system 100 may include a crypto creation component 102 that is configured to generate tokens for exchange through the system 100. The tokens may be issued in limited numbers, ensuring that they remain exclusive and valuable. The tokens may be redeemable for fiat currency for the amount paid, but there is no requirement that the tokens be redeemable for cash. The tokens may entitle the owner to certain benefits such as access to an inventory of exclusive items not available to other customers. These exclusive items may be priced in tokens which may be used to purchase the exclusive items. Some example use cases of purchasing exclusive items are described in greater detail below.

The system 100 may also include a community component 104 configured to manage registration of community members, qualification of registered users, and compliance with any community requirement. As will be described in greater detail below, access to the customer loyalty program and corresponding tokens may be governed by a set of rules or criteria that allows a user to become a member of the customer loyalty program. The community component 104 may enforce these rules or criteria and allow tokens to be distributed to qualified users.

The system 100 may also include a mapping component 106 configured to generate an encoded mapping associated with a respective token. For example, the mapping component 106 may generate a barcode link to an associated token. Users may redeem hard currency with the mapping. In one example, the system 100 may include connections to a distribution system, and the user may present the barcode for scanning. Upon scanning, the distribution system may issue hard currency for the value associated with the token. In other examples, the mapping (e.g., barcode) may be used to purchase the exclusive goods or services, e.g., the presentation of the barcode indicates that the holder of the barcode is eligible for an exclusive benefit associated with the token(s) from which the barcode was generated. As will be described in greater detail below, this is one manner in which a benefit of the customer loyalty program may be transferred to a different user.

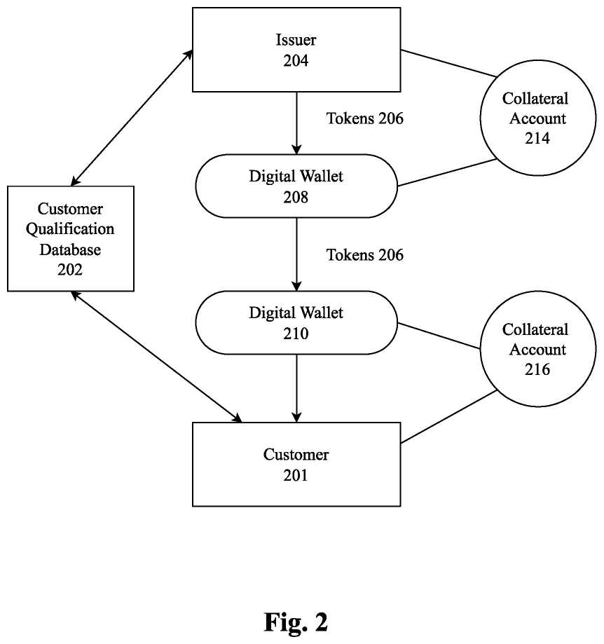

FIG. 2 illustrates the distribution of the cryptocurrency to qualified customers of a customer loyalty program according to various example embodiments. The customers 201 may be vetted for specific qualifications. Again, some specific use cases describing example qualifications will be described in greater detail below. Once qualified, the customers 201 may be stored in a customer qualification database 202 and consumer qualification information may be accessed by the system at any time to ensure that a respective user meets any qualifications for participation. For example, a token issuer 204 may set various requirements on the system.

The issuer 204 may have a digital wallet 208. The issuer 204 may create token(s) 206 that are stored in the issuer digital wallet 208. The token(s) 206 may be transferred by the issuer 204 to a digital wallet 210 of a customer, e.g., customer 201. Each issuer 204 and customer 201 may have respective collateral accounts 214, 216 to meet member requirements or qualifications. In one example, the customer 201 may transfer currency from their collateral account 216 to the collateral account 214 of the issuer 204 for the purposes of purchasing the token(s) 206. Banks, other financial institutions, or redemption centers may interact with the collateral accounts 214, 216 to facilitate hard currency redemption. In some example embodiments, the token(s) 206 may be transferred to the digital wallet 210 of the customer 201 without a corresponding currency transfer, e.g., the token(s) 206 are earned in different manners.

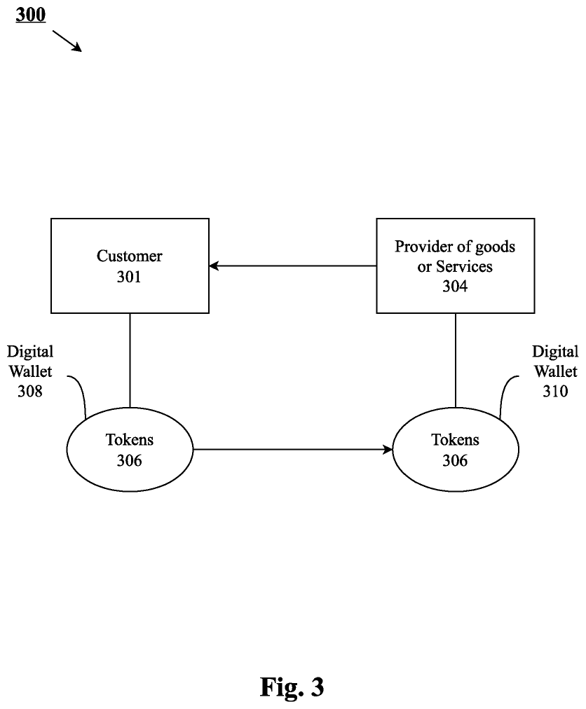

FIG. 3 illustrates a flow chart 300 for using the cryptocurrency to purchase goods or services 350 from a provider of goods or services 304 according to various example embodiments. In this example, it may be considered that the customer 301 is a qualified customer that is a member of the customer loyalty program of the provider of goods or services 304. It may further be considered that the provider of goods or services 304 may be the issuer of the currency or, in some example, the issuer may be a third party that is an administrator of the customer loyalty program for the provider of the goods or services. In this example embodiment, the customer 301 holding tokens 306 may transfer one or more tokens 306 from their digital wallet 308 to a digital wallet 310 of the good or services provider 304. In this example, the one or more tokens 306 may be associated with a specific benefit that entitles the customer 301 to purchase the specific goods or services 350, e.g., the token 306 may include information in the blockchain that the holder of the token 306 is entitled to purchase the goods or services 350. When the good or services provider 304 receives the one or more tokens 306 and verifies that the one or more tokens 306 entitle the customer 301 to the goods or services 350, the goods and services provider 304 may then transfer the goods or services 350 to the customer 301.

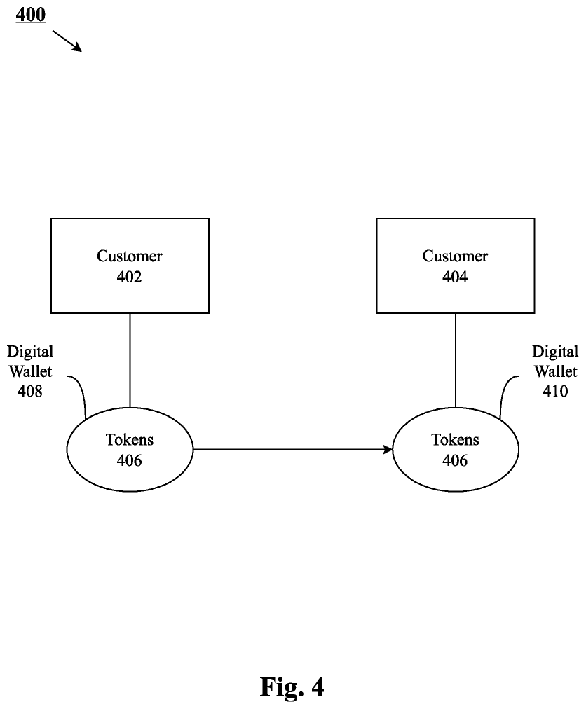

FIG. 4 illustrates a customer-to-customer cryptocurrency transfer according to various example embodiments. In this example each customer 402 and 404 has a corresponding digital wallet 408 and 410. The digital wallet 408 of the customer 402 may have one or more tokens 406 associated with the customer loyalty program. The customer 402 may desire to transfer one or more tokens 406 to the customer 404. There may be various types of transfers of the tokens 406 available. In a first example, the customer 404 may be a verified customer of the customer loyalty program and the transfer of the one or more tokens may entitle the customer 404 to the exact same benefits as the customer 402. In this example, the one or more tokens 406 that are transferred to the digital wallet 410 of the customer 404 will indicate the customer 404 may use these tokens for the same benefits as customer 402.

In a second example, only some of the benefits of the customer 402 may be transferred with the one or more tokens 406 to the customer 404. For example, the benefits of the token 406 for the original customer 402 may include the option to purchase two exclusive items, e.g., item 1 and item 2. However, only the benefit of purchasing the exclusive item 1 may be transferable. Thus, when the one or more tokens 406 are transferred to the digital wallet 410 of the customer 404, the one or more tokens 406 may be altered (e.g., the block associated with this transaction) to indicate the current holder of the token 406 may only purchase the exclusive item 1. This transfer of only some of the benefits may be linked to the type of token, e.g., the token 406 is originally generated with information indicating only the original recipient is entitled to the benefits of purchasing exclusive items 1 and 2 and subsequent holders are only entitled to purchase the exclusive item 1. In other examples, the transfer of only some of the benefits may be contingent on an identity of the customer 404, e.g., if the customer 404 has a same or higher loyalty level as the customer 402, all the benefits may transfer, whereas if the customer 404 has a lower loyalty level than the customer 402 only some of the benefits may transfer. In any of these scenarios, the rule related to the transfer may be recorded in the token 406 and the token may be altered as necessary to convey the correct benefits to the member 404.

In a still further example, the benefits may not be non-transferable. For example, the one or more tokens may be associated with a monetary value, e.g., $100. The customer 402 may transfer the token 406 having the monetary value to the customer 404. However, upon transfer the benefits (e.g., the ability to purchase the exclusive items 1 and 2) may expire. Thus, the customer 404 may only use the token 406 to buy standard products for the associated monetary value. Again, this expiration of the benefits may be recorded on the blockchain indicating the subsequent holder of the token 406 does not have the benefits associated with the original holder of the token 406.

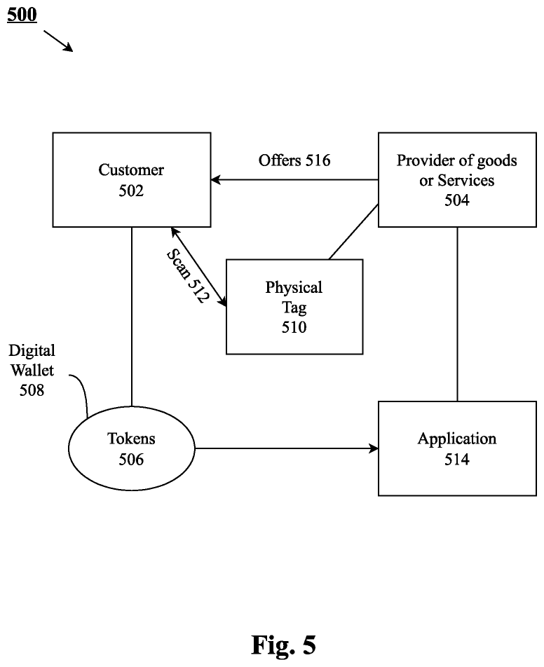

FIG. 5 illustrates a flow chart 500 for using the cryptocurrency to receive offers 514 from a provider of goods or services 504 in a brick and mortar location of the provider of goods and services according to various example embodiments. In this example, it may be considered that the customer 502 has a digital wallet 508 that includes the cryptocurrency tokens 506 associated with the provider of goods and services 504. In this example, the customer 502 may be at a brick and mortar location (e.g., a physical location such as a retail store) of the provider of goods and services.

Certain merchandise at the physical location may have an associated physical tag 510. The physical tag 510 may be directly attached to the merchandise or may be associated with the merchandise in a different manner, e.g., located near the merchandise, located near a photo of the merchandise, etc. The physical tag may include a machine readable code, e.g., a bar code, a quick response (QR) code, a radio frequency identification (RFID) tag, etc.

The customer 502 may activate an application on their mobile device that reads or scans 512 the physical tag 510, e.g., using a camera application. The customer 502 may then send the information related to the physical tag to the provider of goods and services 504 (e.g., an application 514 or website hosted by the provider of goods and services) along with the link to the digital wallet 508 including the tokens 506. The application 514 may then verify the identity of the customer 502 based on the tokens 506 and any offers 516 that are applicable to the customer 502 related to the merchandise associated with the physical tag 510. This offer 516 information may then be sent by the application 514 to the customer 502 so the customer may decide whether to accept the offer 516.

In this example, it can be seen that the token 506 may act as a secure identifier of the customer without resorting to other types of credential information. Furthermore, the combination of the tokens 506 and the information from the physical tag 510 may act as an “inventory revealer”, e.g., provides information to the customer 502 about any offers that are associated with the merchandise which the customer 502 is interested.

The following will provide an example use case of a customer loyalty program for a luxury goods retailer using the example cryptocurrency tokens. In this example, the retailer will be fictitiously named POTEX and the tokens will be termed POTEX tokens. Consider the scenario where POTEX is a luxury watch and jewelry store. The use of the POTEX token revolutionizes the customers' experience and intertwines the elegance of high-end product availability with assurances of security and recognition of its key clients. In the course of POTEX's luxury retail experience, customers earn the right to purchase the limited-issue POTEX token. The POTEX Token sale process is designed to reward and recognize the loyalty and engagement of POTEX's clients.

Customers may begin their journey with POTEX through their initial purchases of luxury watches and jewelry. Each purchase is not just a transaction, but a step towards building a relationship with the brand that entitles the customer to purchase POTEX tokens. The opportunity to purchase POTEX tokens is linked to this customer journey. The system is designed to quantifiably reward those who have shown consistent loyalty and patronage by allowing them to purchase POTEX tokens. POTEX tokens open a world of exclusive inventory and client recognition.

The criteria for earning the right to purchase these tokens may be multifaceted including purchase history, engagement, and brand advocacy. POTEX tokens provide their holders exclusive access to watches, jewelry, and/or events that can only be purchased using the POTEX tokens. The POTEX tokens are issued in limited numbers, ensuring that they remain exclusive and valuable. They are always redeemable for fiat currency for the amount paid, but few would want to redeem them for cash because holding POTEX tokens entitles the owner to see inventory of exclusive items not available to other customers. These exclusive items are priced in POTEX tokens which must be used to purchase them.

POTEX tokens are the currency of a reward for a relationship built over time. It is a system that values and cherishes the loyalty of its customers, offering them a unique way to be part of the POTEX universe. The POTEX tokens, thus, quantify a meaningful relationship-a blend of trust, loyalty, and the shared journey between the customer and POTEX. The wallet containing the POTEX tokens opens up a world of opportunities to purchase exclusive items that are not available to clients who do not own the POTEX tokens. Inventory and purchase opportunities are only revealed to holders who link their digital wallet to the POTEX web site. The linking of the wallet may be the exclusive identifier of the customer as no password or customer ID that may be compromised is required.

At the physical store, the POTEX application including the POTEX wallet may scan an exhibition piece to see its availability for the POTEX token holder. The general public may never be aware that the exclusive piece is even available for sale.

The history of each POTEX token is recorded on the blockchain and serves as an immutable history and identifier of the owner of each POTEX token. All POTEX token transactions are recorded onto the blockchain thereby identifying the holder of the POTEX token without the need for identification or physical recognition of the customer.

In some examples, at POTEX, the top customers who maintain more than a predetermined number of POTEX tokens (e.g., 2 million POTEX tokens) in their wallet may have the added benefit of being able to transfer POTEX Tokens to those who did not receive the POTEX tokens directly from POTEX. This is a valuable additional benefit for POTEX's most loyal customers. The right to transfer these POTEX Tokens is validated and recorded into the blockchain thus ensuring security and an immutable history.

The POTEX tokens may become the cornerstone of a unique ecosystem where access to rare and luxurious items is granted by POTEX to its most loyal customers, and their transferees. Special Inventory is revealed to holders of threshold levels of POTEX Tokens. Accessibility to exclusive pieces of jewelry or timepieces is dependent on how many tokens are held in a wallet. POTEX tokens may be used to purchase these items, which allows a customer to cash in on their loyalty. Transferability allows loyal customers to “share the wealth” with their friends and family when the “Transfer Feature” is unlocked as validated by a record on the blockchain.

The POTEX token system extends the concept of exclusivity and privilege by leveraging the power of blockchain technology. POTEX's use of this technology ensures loyalty and secure authentication of loyal customers. Unlike conventional methods of identifying loyal customers which rely on passwords or physical identification (which can be vulnerable to theft or fraud), POTEX tokens provide a more secure and seamless alternative. Each POTEX token holder has a unique digital identity on the blockchain, linked to the number of tokens they own. This identity is more than just a number or a password; it's a sophisticated digital signature that is intricately tied to the individual's transaction history and interactions with POTEX. This blockchain-based identification system effectively makes POTEX tokens a definitive marker of an individual's status as a privileged POTEX customer. The need for traditional passwords or ID verification is rendered obsolete, replaced by a more secure, efficient, and user-friendly system in the form of a digital rewards token and associated transactions are recorded onto the blockchain. Unlike a POTEX salesperson who “knows” the “good” customers (and who may or may not remain a POTEX), the POTEX token provides an immutable record of a holder's loyalty.

Customers can engage in transactions with the assurance that their identity and exclusive rights are protected by one of the most advanced technologies available. By integrating this level of security into its loyalty program, POTEX has not only enhanced the exclusivity of its customer experience, but also elevates the standard of security and trust in the luxury retail sector. POTEX tokens are a testament to how innovative use of technology can harmonize luxury, exclusivity, and security in the modern retail landscape. The versatility and acceptance of POTEX tokens may even encourage other luxury brands to accept them as owners can be identified as exclusive-level clients, and the tokens are always redeemable for cash.

The system with its robust security features allows customers to “prove” who they are, using an innovation in blockchain technology that can be adapted across multiple industries. Customers enjoy exclusive and safe access to luxury goods and retailers have a new way to build relationships and trust.

In another example use case, the issuer of the tokens may be a restaurant reservation entity (e.g. RESY, Open Table, etc.). In this example, the restaurant reservation entity may issue tokens that include the benefit of unlocking exclusive reservations that are not available to other customers.

In a further example use case, the issuer of the tokens may be an event ticketing entity (e.g. Ticketmaster, Seat Geek, etc.). In this example, the event ticketing entity may issue tokens that includes the benefit of unlocking tickets for exclusive events that are not available to other customers.

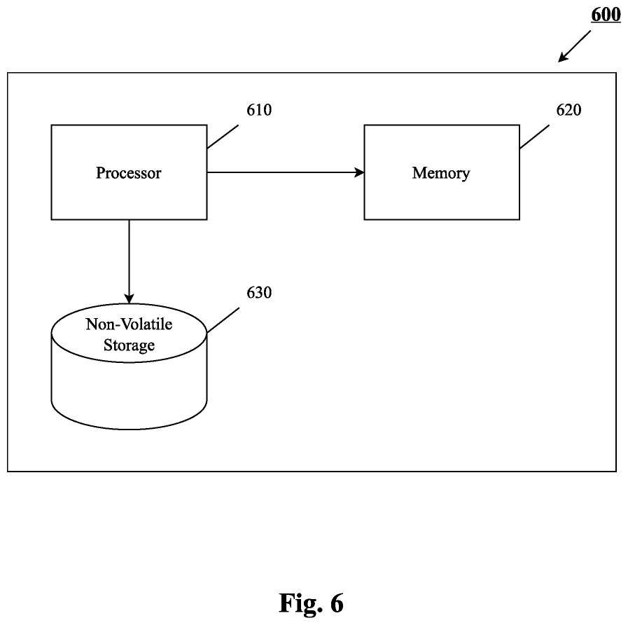

FIG. 6 shows an illustrative implementation of a computer system 600 that may be used in connection with any of the embodiments of the disclosure provided herein. The computer system 600 may include one or more processors 610 and one or more articles of manufacture that comprise non-transitory computer-readable storage media (e.g., memory 620 and one or more non-volatile storage media 630). The processor 610 may control writing data to and reading data from the memory 620 and the non-volatile storage device 630 in any suitable manner. To perform any of the functionality described herein, the processor 610 may execute one or more processor-executable instructions stored in one or more non-transitory computer-readable storage media (e.g., the memory 620), which may serve as non-transitory computer-readable storage media storing processor-executable instructions for execution by the processor 610.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

1. A system, comprising:
a memory; and
a processor communicatively coupled to the memory and configured to:
generate digital currency units of a customer loyalty program, wherein each of the digital currency units comprises a first indication of a benefit of the customer loyalty program associated with the corresponding digital currency unit and a second indication of a transferability of the benefit associated with the corresponding digital currency unit, wherein the second indication comprises a rule indicating whether the benefit is transferable from the user to a second user;
create blocks of a distributed ledger, wherein each block corresponds to one of the digital currency units, wherein each block records the first indication of the benefit corresponding to one of the digital currency units and the second indication of the transferability of the benefit associated with the one of the digital currency units;
communicate each block to a distributed ledger responsive to exchange of the digital currency unit corresponding to each block;
register a user based on one or more predetermined criteria of the customer loyalty program;
validate the user is entitled to the benefit of the customer loyalty program corresponding to a first one of the digital currency units based on the one or more predetermined criteria; and
issue the first one of the digital currency units to the user, wherein the issuing the first one of the digital currency units to the user comprises recording information related to the user on a blockchain responsible for the first one of the digital currency units.

2. The system of claim 1, wherein the processor is further configured to:
receive a request from the user, wherein the request comprises the user linking a digital wallet including the first one of the digital currency units to the system;
validate an identity of the user based on at least the block of the distributed ledger corresponding to the first one of the digital currency units, wherein the validating includes sending transaction details for the first one of the digital currency units to a network of nodes on a blockchain responsible for the block; and
send a response to the user including the first indication of the benefit associated with the first one of the digital currency units and the second indication of a transferability of the benefit of the customer loyalty program associated with the first one of the digital currency units.

3. The system of claim 2, wherein the response further includes a third indication of a number of digital currency units required to access the benefit.

4. The system of claim 3, wherein the processor is further configured to:
receive the first one of the digital currency units from the wallet of the user; and provide the benefit to the user.

5. The system of claim 2, wherein the request comprises an interaction via the wallet of the user and a website of an entity issuing the digital currency units.

6. The system of claim 2, wherein the request comprises an interaction via the wallet of the user at a physical location of an entity issuing the digital currency units.

7. The system of claim 1, wherein each of the digital currency units further comprises a monetary value, wherein each of the digital currency units is redeemable for the corresponding monetary value.

8. (canceled)

9. The system of claim 1, wherein the one or more predetermined criteria comprises a purchase history of the user, an engagement of the user with an entity issuing the digital currency units, or a brand advocacy of the user for the entity issuing the digital currency units.

10. (canceled)

11. The system of claim 1, wherein the benefit comprises an ability of the user to purchase goods or services that are only available to holders of the digital currency units.

12-20. (canceled)

21. The system of claim 1, wherein the rule indicates that the second user is entitled to the benefit upon transfer of the first one of the digital currency units.

22. The system of claim 1, wherein the rule indicates that the second user is entitled to the benefit upon transfer of the first one of the digital currency units only when the second user is validated using a same predetermined criteria of the one or more predetermined criteria used to validate the user.

23. The system of claim 1, wherein the rule indicates that the second user is entitled to a portion of the benefit upon transfer of the first one of the digital currency units.

24. The system of claim 1, wherein the rule indicates that the second user is not entitled to the benefit upon transfer of the first one of the digital currency units, wherein the second indication is updated to indicate the benefit is expired.

25. The system of claim 1, wherein, upon transfer of the first one of the digital currency units to the second user, the blockchain responsible for the first one of the digital currency units is updated with information related to the second user.
